(19) United States
(12) Patent Application Publication
(10) Pub. No.: US 2015/0163562 A1
(43) Pub. Date: Jun. 11, 2015

(54) Live and Pseudo-Live Video Feed Selection Based on Fantasy Sports Team

(71) Applicants: Martin Leventhal, Brooklyn, NY (US); Moshe Bienenfeld, Brooklyn, NY (US); Meir Bienenfeld, Brooklyn, NY (US)

(72) Inventors: Martin Leventhal, Brooklyn, NY (US); Moshe Bienenfeld, Brooklyn, NY (US); Meir Bienenfeld, Brooklyn, NY (US)

(21) Appl. No.: 14/616,807

(22) Filed: Feb. 9, 2015

(51) Int. Cl. H04N 21/81; H04N 21/2187; H04N 21/234; H04N 21/8549; H04N 21/44; H04N 21/2668; H04N 21/458; H04N 21/462; H04N 21/2665; H04N 21/845; H04N 21/435; H04N 21/2343

(52) U.S. Cl. CPC H04N 21/8126; H04N 21/435; H04N 21/2187; H04N 21/23424; H04N 21/8549; H04N 21/23439; H04N 21/2668; H04N 21/458; H04N 21/4622; H04N 21/2665; H04N 21/8456; H04N 21/44008; H04N 21/44016

(57) ABSTRACT

A merged video feed from those provided for each live sports game is composed based on players on a fantasy sports team. In real-time, video clips from within the video feeds are selected and shown, the video clips being of teams and/or games where one (or more) of the players on the fantasy team are either carrying out an action which is likely to lead to a point or which results in a point. The “point,” for purposes of this disclosure, refers to points scored for the fantasy sports team, as defined by scoring rules for a specific fantasy sports league. The video clips are then sent via a network in real-time or near real-time to the display screen.

### FIELD OF THE DISCLOSED TECHNOLOGY

The disclosed technology relates generally to video feeds, and, more specifically, to selection of video feeds to display.

### BACKGROUND OF THE DISCLOSED TECHNOLOGY

Fantasy sports games and fantasy sports betting are a popular way to choose your own team made up of your favorite players. In a fantasy baseball team, you might choose your first basemen from the Yankees, your short stop from the Cubs, and your right fielder from the Marlins. In a fantasy football game, you might choose your quarterback from the Giants, your field goal kicker from the Patriots, and your wide receiver from the Bills. These players that you choose make up your “fantasy sports team,” defined for purposes of this disclosure as “a collection of real players in a sports league.”

In a fantasy sports league, defined for purposes of this disclosure as “a game comprising multiple fantasy sports teams, each team associated with a person or entity,” points are awarded when one of your players carries out an action. For example, in some football fantasy sports leagues, each time one of your players scores, or throws a pass leading to, a touchdown, field goal, or extra point, your fantasy sports team is awarded these points. In other leagues, an action might consist of running a certain number of yards. As such, an “action,” for purposes of this disclosure, is defined as, “an event within a game which will allot points to a fantasy sports team if the event is carried out by a player on the fantasy sports team.”

Of course, fantasy sports teams and scoring thereof have long been known. Various tools are also available to receive data about each player during and after a game and then rank your fantasy sports team to determine how many points you have earned. The problem is that these tools are not as exciting as watching a real game. Looking at numbers and statistics after a game is not the same as actually watching the players going head to head against one other and carrying out plays in a real game.

Sonic attempts have been made to bring the excitement of real games to fantasy games. For example, U.S. Pat. No. 7,769,600 discloses a system to tease out media content associated a sports game and send such content to a user for viewing. Another concept, disclosed in U.S. Patent Publication 2009/00064221, switches a television station based on what is happening in a current sporting event. Still other concepts allow you to watch multiple games at the same time.

While these references allow one to see some of the action that their fantasy sports players are carrying out, there is still an unmet desire to be able to view a fantasy sports team in the way one views a real game.

### SUMMARY OF THE DISCLOSED TECHNOLOGY

Embodiments of the disclosed technology generate and show a merged video feed. Cameras capturing video of multiple live sports games generate a feed for each sports game. From the video feeds of available live games, those which include players on a fantasy sports team are selected for display on a screen under the operative control of a viewer. This viewer can be the owner (one having operative control over the players on the team) of the fantasy sports team being displayed. In real-time, video clips from within the video feeds are selected and shown, the video clips being of teams and/or games where one (or more) of the players on the fantasy team are either carrying out an action which is likely to lead to a point (a precursor action or conditions in a play of a game which, based on past history of the game, occurs before a point is scored, e.g. being less than 15 yards from the goal in football or being up to bat in baseball), or which results in a point. The “point” for purposes of this disclosure, refers to points scored for the fantasy sports team, as defined by scoring rules for a specific fantasy sports league. The video clips are then sent via a network in real-time or near real-time (defined as within 30 seconds and/or based on delay to receive, process, transmit, and account for regulations requiring live broadcasts to be on a time delay such as 7 seconds) to the display screen.

Video clips closest to real-time are given priority in a step of sending, as recorded video clips can also be used on a time delay, when showing another video clip where points are being, or are about to be, scored. Selected video clips can be queued for sending to the display screen, the queue residing on a storage device at the location (electrically coupled or part of a local area network) of the display screen or at a remote location. A video clip occurring later in time can be placed ahead of a previously (prior) queued video clip, based on more points being scored (or likely to be scored) for the fantasy sports team. Once a queued video gets too old, that is, having a start time or end time past a pre-determined period of time from the present, it can be dropped from the queue. This pre-determined period of time can be proportionally greater for video clips corresponding to more points for the fantasy sports team.

Two simultaneously sent merged video feeds, each showing a different fantasy sports team in the merged feed, can be simultaneously sent to the display device.

The step of “sending” can further include instructing a recording device to record at least a portion of one of the video feeds of the live sports games and to exhibit the video clips on said display. The clips exhibited can be switched between recorded video feeds and live sports games, based on the parameters set out above with respect to the steps of “selecting” and “queuing.”

A merged video feed can be generated, in further embodiments of the disclosed technology, based on receiving data, via a network node, of live video feeds for at least two concurrent sports games, receiving a list of players on a fantasy sports team, determining when a player of the fantasy sports team is exhibited in one of the live video feeds, and determining if the player is carrying out an action likely to lead to a point for the fantasy sports team. Based on this, a merged video feed is sent to a display device (which includes sending from the same device itself to a viewing screen) with a merged video feed having one of the live video feeds exhibiting the player carrying out an action likely to lead to the point for the fantasy sports team. At a later time, a different feed of the live feeds, with a different player carrying out such an action, is sent. This can be carried out for two different fantasy sports teams simultaneously in one merged feed, or two merged feeds where one merged feed is for each fantasy sports team.

When two players of the fantasy sports team are carrying out an action likely to lead to a point for the fantasy sports team, and each player of the two players is exhibited in a different live video feed, the live video feeds can be combined and sent together in a simultaneous merged video feed to the display device. That is, two different video feeds are shown at the same time, each taking up a part of the screen in the merged video feed display. Or, instead/in other embodiments/in combination with the above, the video feed showing a player who is scoring or likely to score more points is shown first, while the remaining video feed is shown next, on a time delay. The remaining video feed can be dropped if it does not result in a point being scored. While a video clip is queued for playback, when a new action likely to lead to a point for the fantasy sports team is detected before the delayed feed is sent to the merged feed shown on the display device, sending a video feed showing said new action to said display device, this new action can be shown first, either live or by placing it ahead in the queue. This can happen when, for example, the new action detected scores or is likely to score a greater number of points for the fantasy football team.

Sometimes, a player on the fantasy sports team scores a point, but this was not shown in the merged video feed (either because another player scoring a point was being shown or the detection of the point score was not made ahead of time). In such a case, the player scoring the point can then be shown doing same in the merged video feed on a time delay basis. “Time delay,” for purposes of this disclosure, is differentiated from “real time” and “near real time,” in that video content is shown slower than is being sent from a broadcaster through network nodes to the display device and is at least 15 seconds, or 30 seconds, depending on embodiment, behind the time of display for a live broadcast on the same display device. A “near real time” broadcast is sent as quickly as possible from the point of transmission, excepting for delays due to equipment used to transmit the image from the point of recording to the point of display and includes up to a 7 second additional intentional delay, such as required by a regulatory authority.

A recording device can be instructed to record at least a portion of one of the video feeds of the live said sports games and to exhibit the portion on the display later, such that switching between displaying the portion recorded and at least one of the live video feeds is based on an action of a player on the fantasy sports team which is more likely to result in more points for said fantasy sports team. There can thus be a seamless flow between recorded and live clips of video feeds into the merged video feed.

“Substantially” and “substantially shown,” for purposes of this specification, are defined as “at least 90%,” or as otherwise indicated. Any device may “comprise” or “consist of” the devices mentioned there-in, as limited by the claims.

It should be understood that the use of “and/or” is defined inclusively such that the term “a and/or b” should be read to include the sets: “a and b,” “a or b,” “a,” “b.”

### BRIEF DESCRIPTION OF THE DRAWINGS

FIG. 1 shows a high level flow chart of a method for merging a video feed.

FIG. 2 shows a high level diagram of steps taken towards a decision as to which of a plurality of video feeds to include in a merged video feed at any given time, in embodiments of the disclosed technology.

FIG. 3 shows a high level diagram of devices used to view a merged video feed.

FIG. 4 shows a display device with two fantasy teams being displayed simultaneously, in an embodiment of the disclosed technology.

FIG. 5 shows an example of points awarded for a fantasy team, in embodiments of the disclosed technology.

FIG. 6 shows an example of a data table used in conjunction with switching of video feeds into the merged feed, in embodiments the disclosed technology.

FIG. 7 shows a high-level block diagram of a device that may be used to carry out the disclosed technology.

### DETAILED DESCRIPTION OF EMBODIMENTS OF THE DISCLOSED TECHNOLOGY

Embodiments of the disclosed technology generate and show a merged video feed. Cameras capturing and creating video of multiple live sports games generate a feed for each sports game. From the video feeds of available live games, those which include players on a fantasy sports team are selected for display on a screen under the operative control of a viewer. This viewer can be the owner of the fantasy sports team being displayed. In real-time, video clips from within the video feeds are selected and shown, the video clips being of teams and/or games where one (or more) of the players on the fantasy team is either carrying out an action which is likely to lead to a point or which results in a point. The “point” for purposes of this disclosure, refers to points scored for the fantasy sports team, as defined by scoring rules for a specific fantasy sports league. The video clips are then sent via a network in real-time or near real-time to the display screen.

Embodiments of the disclosed technology will become clearer in view of the following discussion of the figures.

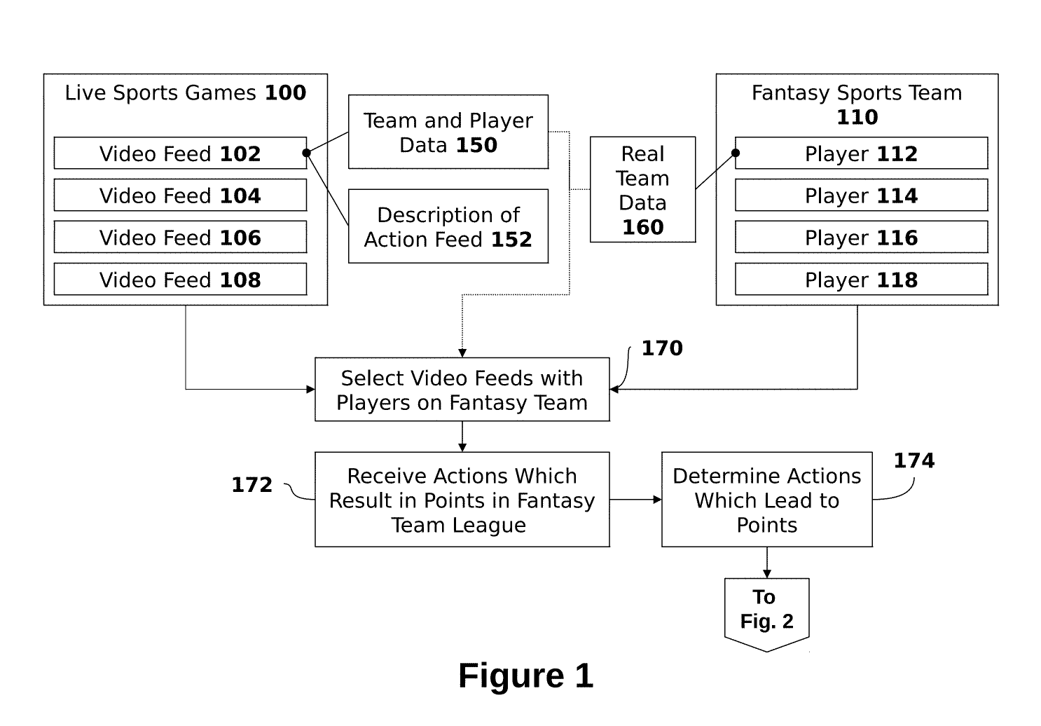

FIG. 1 shows a high level flow chart of a method for merging a video feed. A plurality of live sports games 100 is currently being played. Each game is available for public viewing (by paying for rights to same or free over the air) in a video feed, represented by video feeds 102, 104, 106, and 108. That is, each video feed is of a live game being played concurrently. In each video feed 102, 104, 106, and 108 are two (or more) teams playing against one another having associated team and player data 150. This team and player data can be obtained from the league or organization in which the teams are members, or from third parties who obtain or record this data. Further, in embodiments of the disclosed technology, a description of the action 152 for each feed is available. This describes what is currently going on in the game, such as, “Giants on the 40 yard line,” “Raiders first down and 10 yards to go,” “Player 112 attempted a field goal kick.” Some of these descriptions or events may be determined as likely lead to action that scores a point in a fantasy sports league. An action which will “likely lead to an action that scores a point” is defined further as “an event in a game which has been determined to be one which happens at least 50% of the time before an action which results in a point, as defined by a fantasy league in which the subject fantasy team is a member.”

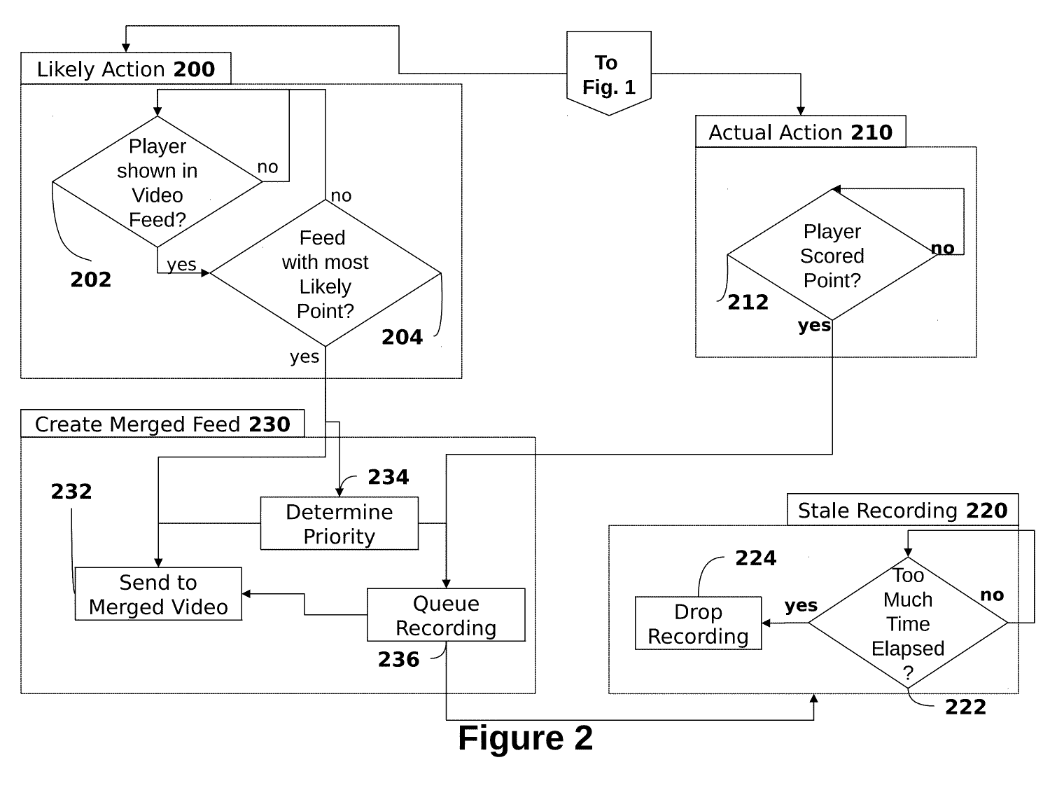

A fantasy sports team 110 (as defined in the background), as shown in FIG. 1, is a team with players chosen by a participant in the fantasy sports game. In this case, players 112, 114, 116, and 118, by way of example and representing any number of players on the fantasy sports team 110, are in the team. Each player has associated therewith real team data 160, indicating what team this person actually plays for. Thus, the intersection of available video feeds (102-108) and teams on which the players (112-118) on the fantasy sports team play can be used to determine which video feeds to monitor or choose for playing on a feed to be merged. In step 170, therefore, the video feeds (102-108) with the players on the fantasy team (112-118) are selected. Within these video feeds that are selected, in step 172, actions which result in points for the fantasy team league are determined. This can be accomplished by a person or several people manually entering data about what is happening in the games on the video feeds selected, by extracting data such as closed captioning data, by scanning statistical information and game data provided by third party sources, and so forth. The actions which can lead to scoring points, in step 174, for the fantasy sports team 110, are then determined. Based on these actions which lead to points (or which have led to points already), one of the video feeds (102-108) is selected for display in a merged feed. This will be explained in further detail with reference to FIG. 2.

FIG. 2 shows a high level diagram of steps taken to decide which of a plurality of video feeds to include in a merged video feed at any given time, in embodiments of the disclosed technology. After carrying out the steps in FIG. 1 to determine which video feeds to select and which potential players within the video feed to show, one, two, or all of sub-routines 200, 210, and 220 are carried out to create a merged feed in sub-routine 230. This is accomplished as follows.

First describing the likely action 200 sub-routine, in step 202, if one of the players on the fantasy football team is playing in one of the games for which a live video feed is available, then, in step 204, it is determined if this player will likely score a point. If either of these steps results in a “no” answer, then the steps are repeated until there is a “yes” answer. In the first iteration, as soon as a player is found, the person is shown in the merged video feed in step 232. That is, any one of the games currently playing with one of the members of the fantasy football team 110 will be shown at the beginning of the merged video. The default, when no player is determined to be scoring a point or likely to score a point, it simply to show a video feed including a player on the fantasy sports team who is actively playing in the game. Thus, this game will be shown to the viewer in the merged video feed.

However, once more players are available in other games being played at the same time, it must be determined which feed will most likely result in a point, and this feed is shown in a step of 234, where priority is determined between which video feed to show in step 232. In embodiments, a video feed may be shown for a minimum amount of time before switching, and in embodiments, certain events of high priority can be immediately displayed in the merged video feed. Other factors which can affect priority will be described further herein. In some cases, it is eventually determined if the action which is likely to cause a point is over (such as the series of plays before turning the ball over to the other side, or the actual point is scored) before switching to another video feed.

In some cases, it may not have been determined ahead of time that an action would lead to a point. For example, it is not typically predictable when a player will fumble a ball and the other team will pick up the ball and make a touchdown. As such, using the method described with reference to sub-routine 200 may not result in the video feed with this exciting and point-worthy event being shown. Thus, in sub-routine 210 it is determined if an actual action has resulted in points for the fantasy sports team 110. In step 212, the step is constantly repeated to check if a player carried out an action that resulted in a point for the fantasy sports team. If so, then a recording of the event is queued for playback in the merged video feed 232. The recording may, instead, be sent immediately to the merged video feed, depending on the priority in step 234. As such, a mix of live footage and pre-recorded footage may be queued.

Step 236 of queued video feeds for playback can also occur when a first video feed, for example video feed 104, is being played in the merged video feed and the event is one which is likely to cause, or does cause, points for the fantasy football team 110. However, at the same time, in another video feed, for example video feed 106, a similar such action is taking place simultaneously. Or, it may be too soon to switch video feeds in the merged video due to a minimum amount of a time allowed between switching. In such a case, in embodiments of the disclosed technology, the likely action in sub-routine 200 can be relegated, not to the merged video feed in real-time, but after determining priority in step 234, into a recording where it is then queued in step 236 for later playback.

The queued recordings can be a mix of those where there is a) a likely action 200 and those with b) an actual action 210 that leads to a point for at least one player on the fantasy sports team. It should further be understood that each time a video is queued, its start and end time can be adjusted by an operator or by the end of a play, point score for the fantasy team (or pre-determined amount of time after such a score), or the like. Further, when carrying out step 236 to queue a video for playback in the merged video feed, the next video (or part thereof) can be placed at the beginning, middle, or end of the queue depending on determined priority in step 234. In this manner, a queue of highlights from each of the plurality of video feeds is constantly queued, though preference can be given for live playback.

This leads into a discussion of sub-routine 220 for stale recordings. As described above, any video clip having a distinct start and end time can be queued in step 236 and recorded. This can be a live clip with actions that will lead to a point (step 204) showing a player (step 202) who is on the fantasy sports team 110 in one of the video feeds 100 where another clip is currently playing. Or, this can be a past clip where it has been determined in step 212 that a point was scored. As such, a mix of live and past clips are played, but, in embodiments of the disclosed technology, it is desired to keep the merged video feed (step 232) as fresh and close to live as possible. In this manner, one watching the merged video feed while also watching (or while his friends are watching) one of the live game feeds, can see substantially the same content when content from a particular feed is shown.

A problem, however, can arise in that too much time may have elapsed between the time a video clip airs in a video feed (based on either or both of its start time, median time, or end time). In sub-routine 220 it is determined, for each video clip in a queue, whether too much time has elapsed in step 222 for a video clip. This amount of time can be 30 seconds, 1 minute, 2 minutes, 3 minutes, 5 minutes, 10 minutes, or 15 minutes. The time which is considered too much can vary, depending on the number of points that the action scored or was likely to have scored. For example, a touchdown may score a player 6 points in the fantasy league, whereas running 20 yards may score only 0.5 points for the player, or a different player, in the fantasy league. Therefore, when queuing, the touchdown will be placed ahead of the 20 yard run, in embodiments, even when occurring last in time. The touchdown play may run only after a current clip with another two minutes to go finishes, and then the touchdown play lasts another five minutes. Meanwhile, before the touchdown play finishes, a field goal is scored in another game, shown live or nearly live, from its corresponding video feed, and 10 minutes have passed from the time the 20 yard run actually aired and the present time. Here, the 20 yard play can be seen as “stale” because it has been 10 minutes since the play occurred. So in step 222, too much time has elapsed and, in step 224, this recording is dropped. This can occur even if no other plays are taking place in sub-routine 200, or actual plays to air in sub-routine 210. It is desired, in embodiments, to show a live feed of a game versus a stale clip even where the stale clip shows a point being scored.

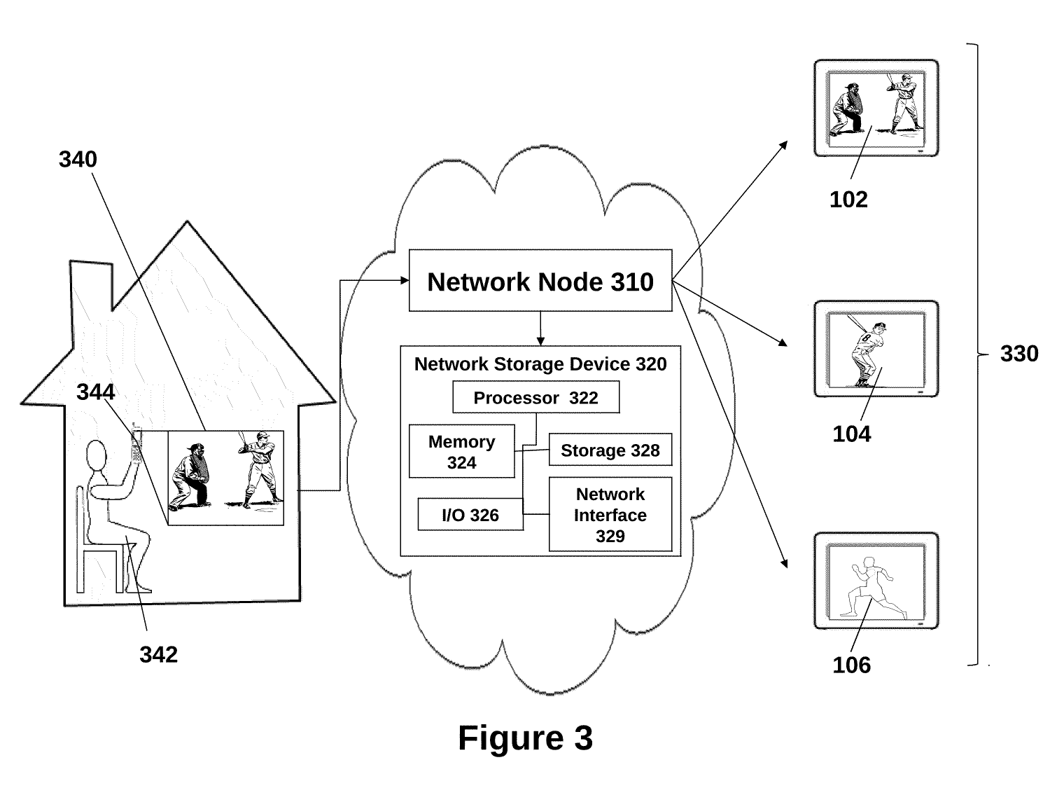

FIG. 3 shows a high level diagram of devices used to view a merged video feed. Video feeds 330 include any of a plurality of video feeds, such as video feeds 102, 104, and 106. Each video feed is of a different live sports game currently being broadcast via television or the internet. Each of these feeds and/or data describing what is taking place in each of these feeds is collated at a network node 310 (a router, switch, or physical hardware device receiving packet-switched or circuit-switched data via a physical cable or wireless transmission).

This network node 310 has attached there-to a network storage device 320 storing at least a part of a video feed or video feed data. In embodiments, the storage 328, a magnetic, optical, solid state, or other data storage device stores each of the live feeds for a period of time, such as the past 10 minutes worth of video. In other embodiments, when a feed is shown in the merged video feed 340, the stored video is deleted from the storage device 328, or the video bypasses the storage altogether. The storage 328 can be used to retrieve video clips of events which passed when they are ready for play, after having been placed in a queue, such as described in step 236 of FIG. 2. The network storage device 320 further can have an input/output for communicating therewith (e.g., a keyboard), memory 324 for volatile storage of data, a processor 322 on which commands are executed, and a network interface 329 to communicate data to other devices.

In a merged video feed 340, at any point in time during operation of methods of the disclosed technology, one, or at least part of one of the video feeds 330 is shown. This merged video feed 340 comprises videos of games which are actively being played (or recently finished within the amount of time designated as “stale”) and which have players on the fantasy sports team of the viewer 342. This viewing device 344 can be a hand-held wireless device with network connectivity receiving data via the network node 310, or it can be on the same physical device as the network node 310. The merged video feed can be a mix of a live transmitted video and locally stored data. For example, when playing a live feed, this is transmitted directly from a camera at a game, via a broadcast network, to the display device of the viewer. However, when showing a clip from a previous time, this is retrieved from a data storage device, such as a television recording device or a local network attached storage device, and played into the merged video feed.

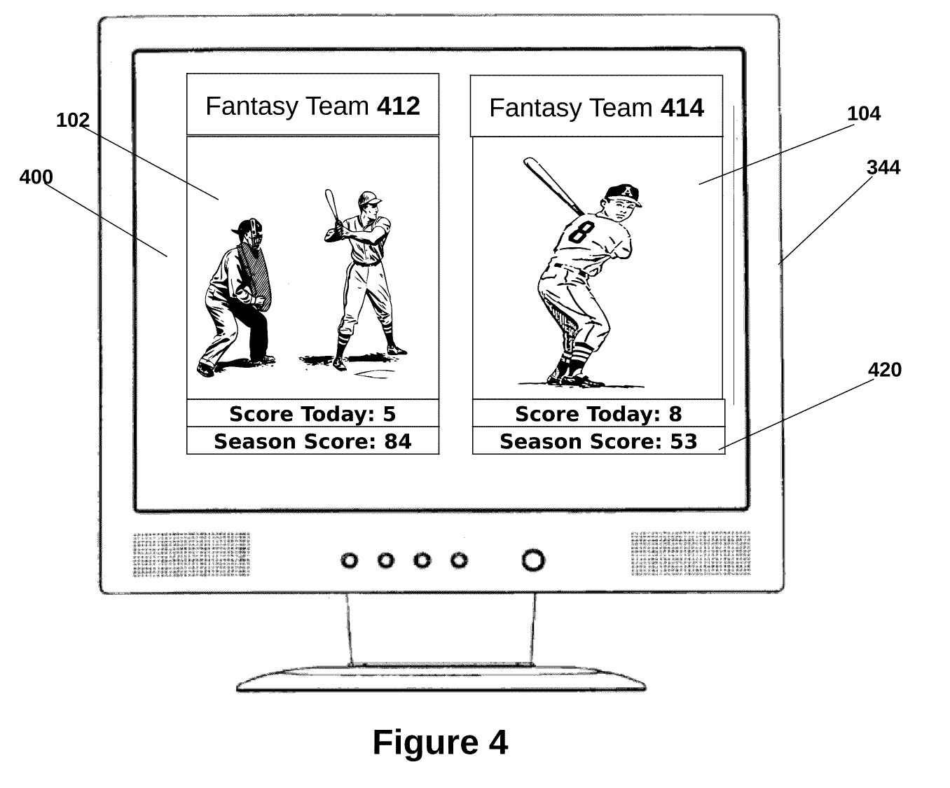

FIG. 4 shows a display device with two fantasy teams being displayed simultaneously, in an embodiment of the disclosed technology. Here, two fantasy teams 412 and 414 are shown along with their scores 420. At the snapshot in time represented in FIG. 4, Fantasy Team 412 is currently showing video feed 102 and Fantasy Team 414 is currently showing video feed 104. At a given time, the same video feeds could be shown for both, where players from each fantasy team are playing in the same game, and a play which results in a point score for each team is taking place or has recently taken place. This can be shown on a device of a viewer 344 having a video display 400.

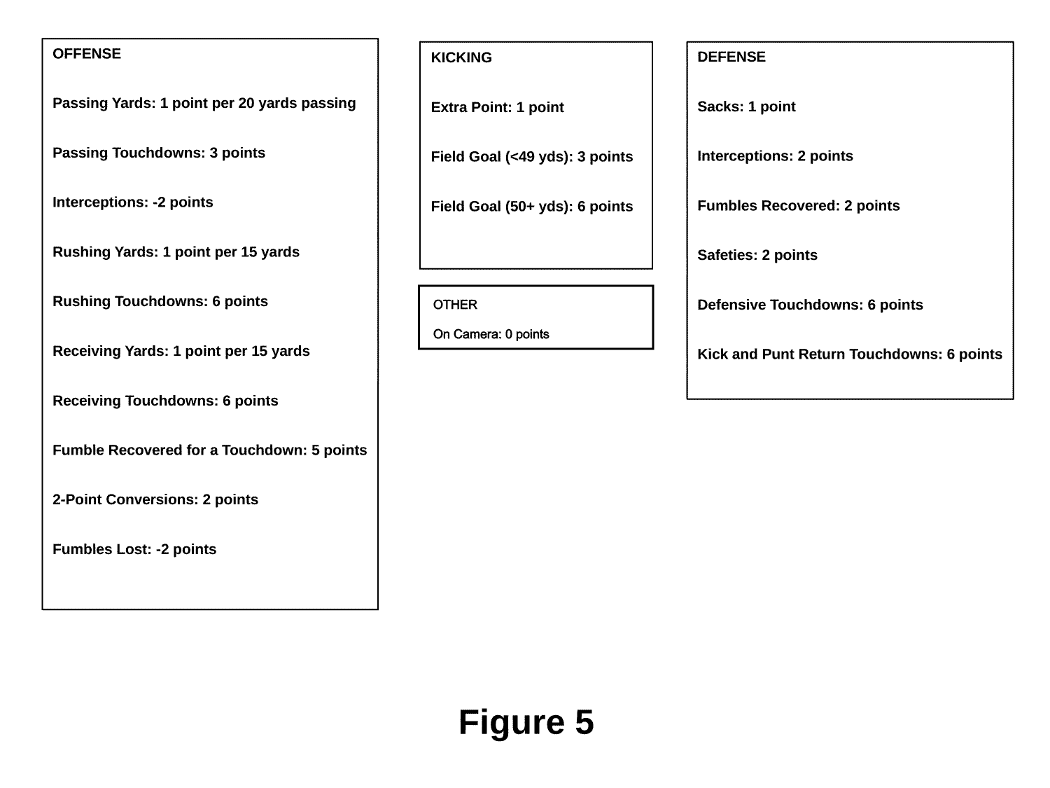

FIG. 5 shows an example of points awarded for a fantasy team, in embodiments of the disclosed technology. Where points are negative, for purposes of this disclosure, in determining what is “more” or “less” points given to a team when showing a video feed, the absolute value of the points are used. Thus, when an event happens which leads up to, or is likely to lead up to, a point score which is higher than that currently being shown, the merged video feed can switch to a feed showing that event instead. Or, when queuing events for placing into the merged feed, an event with a higher score can be placed higher in the queue than one with a lower score.

FIG. 5 includes an additional item which does not score points for the team, but rather can be used in conjunction with, or be the cause of a determination that action leading to a point for a player on a fantasy sports team. Under “Other” there is an “On Camera” action which is zero points. Thus, when no other actions are taking place which the absolute value is greater than zero point score, a player on the fantasy team shown on camera is defaulted to. In other words, when no points are being scored, or as detected, likely to be scored, then the most likely scoring event can be from any player on the fantasy team who is currently playing in the game (not on the sidelines/bench/dugout) and on camera.

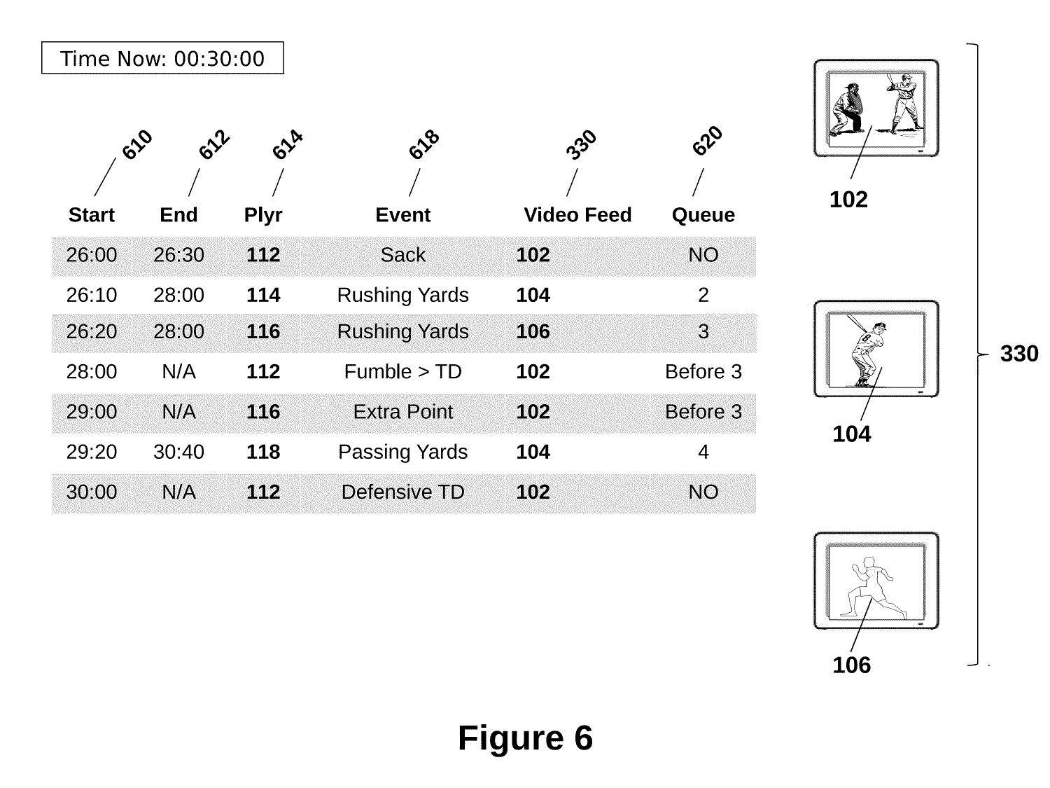

FIG. 6 shows an example of a data table used in conjunction with switching of video feeds into the merged feed, in embodiments of the disclosed technology. Here, video feeds 102, 104, and 106 are shown again for purposes of this example, making up the combined input video fees 330 showing active sports games for which players are playing, that are also on a fantasy sports team. The players 112, 114, 116, and 118, used for this example are as described with reference to FIG. 1. Here, the columns shown refer to the start time 610 of a play which will likely lead to a point being scored for the fantasy team, or which did in fact, lead to same. The end time 612 refers to when this play is over, which is not always known. Instead, in embodiments, a minimum time for showing a video feed is used, and/or the video feed shown simply remains until another event leading to a point for the fantasy team is discovered. The event column 618 refers to the type of event, which, for purposes of this example, corresponds to the events shown in FIG. 5 and the points associated there-with. The video feed 330 refers to which video feed this event and/or player can be found. Finally, the queue column 620 refers to where in the queue (relative to the other entries in the table) the event is placed. For purposes of this example, the time is 30 minutes into the merged video feed being shown with active video fees 102, 104, and 106 being active.

At a time of 26 minutes, player 112 sacked another player and earned points for the fantasy team. Therefore, the associated feed 102 showing this game is shown in the merged feed, in this case, immediately. This immediate showing can be because no other point-worthy events are taking place at the time, or in this embodiment, a switch to a video feed happens whenever a new point event occurs. At 26:10, player 114 has some rushing yards resulting in either the full rushing yards points, or an anticipation thereof, as some of the rushing yards required there-for have been obtained. This can be detected as an event likely to cause a point, so it is placed in the queue to be shown second. Likewise, at 26:20 another player has some rushing yards in another game, so the video feed switches over to the respective feed or queues this video clip to be played next. For the rest of this discussion, we will assume that the video feed 3 is queued.

At 28 minutes, player 112 fumbles the ball and a touchdown is made by the other team, causing some lost points. These points gained (in absolute value, for purposes of the claim language) are more than that of the rushing yards, so it is queued before the rushing yards play or plays, to be placed before the item queued as number 3, because queued item number 2 is already playing in this instance. Luckily for our fantasy sports team, who just lost points, the extra point kicked is by player 116, also on the same fantasy team. As such, this event at 29 minutes is queued next, and again before the event at 26:20. Here, note that these two events last described are both in video feed 102, so the video feed remains. The “extra point” might refer to the actual scoring of same, or the possibility of same as player 116 was simply going for the extra point, and this is an event likely to lead to points.

This brings us past the 29:20 mark when player 118 has some passing yards. At this point, the passing yards are worth the same as the rushing yards of player 116 and the video clip showing same is therefore placed fourth in queue. However, the third queued item began much earlier and may have passed the time when it is considered stale. If it were worth more points, then the stale time might be longer, such as for a touchdown which might not have any stale time. Here, queued item number 3 might be dropped from the queue entirely due to its relatively low number of points for the fantasy team and age. Thus, the clip queued as 4, or whose time has arrived in real-time, is played next, in embodiments from video feed 104. Then, player 112, who previously sacked someone back at the 26 minute mark, is on a rampage, and at the 30 minute mark, scores a defensive touchdown. The system might not detect this until the point is scored, say, at the 31 minute mark, but as video feed 104 was being shown on a time delay from queued item 4, it might jump to video feed 102, when the play that led to the defensive touchdown began, because this play is worth over a threshold of points bringing it to the top of queue or for immediate playback. The play might still be going on, and as such, be recorded as earlier moments in the play are played.

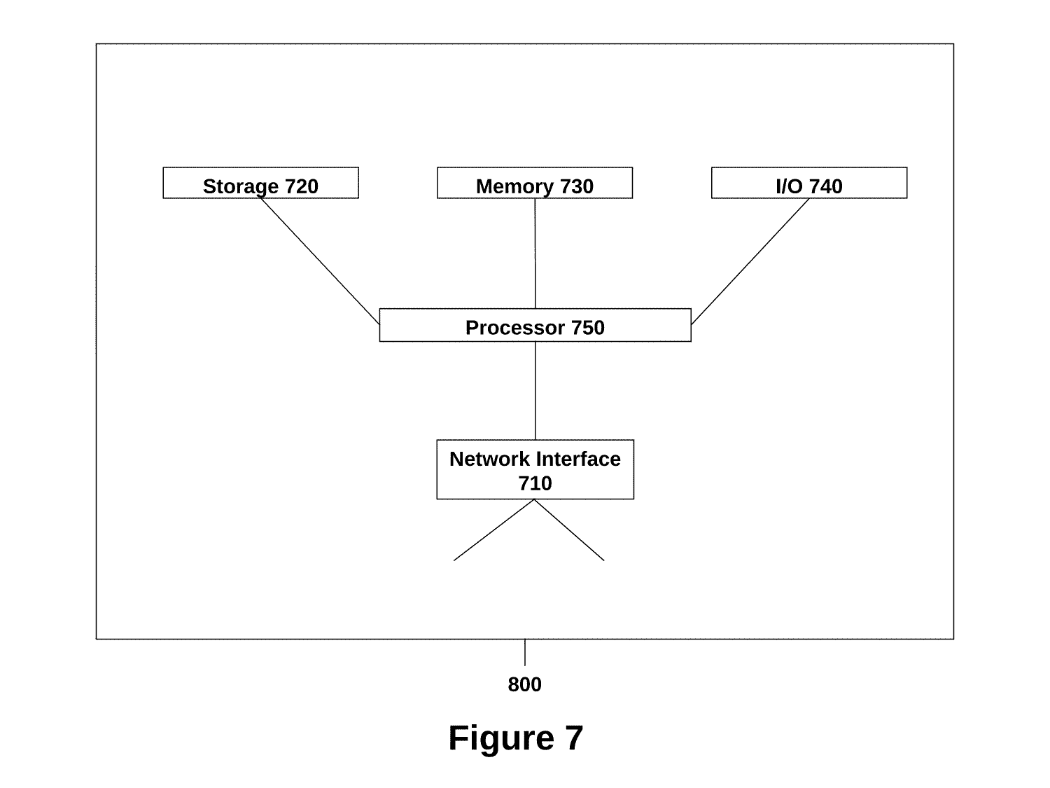

FIG. 7 shows a high-level block diagram of a device that may be used to carry out the disclosed technology. Device 700 comprises a processor 750 that controls the overall operation of the computer by executing the device's program instructions which define such operation. The device's program instructions may be stored in a storage device 720 (e.g., magnetic disk, database) and loaded into memory 730 when execution of the console's program instructions is desired. Thus, the device's operation will be defined by the device's program instructions stored in memory 730 and/or storage 720, and the console will be controlled by processor 750 executing the console's program instructions. A device 700 also includes one or a plurality of input network interfaces for communicating with other devices via a network (e.g., the internet). The device 700 further includes an electrical input interface. A device 700 also includes one or more output network interfaces 710 for communicating with other devices. Device 700 also includes input/output 740 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device for illustrative purposes. It should also be understood by one skilled in the art that the method and devices depicted in FIGS. 1 through 6 may be implemented on a device such as is shown in FIG. 7.

It should further be understood that items used in video production and networks can be used to carry out the methods. These include video cameras (optical input devices which store moving video), analog to digital converters, network hardware (routers, switches), handheld electronic devices with display screens, and cables which electronically couple two devices over which electric current and/or data can be sent. Wireless transmission and receiving devices can also be used to send/receive data, such as one or more video feeds. The data can be sent via a packet-switched network (data broken into individual pieces, sent, and re-joined into a video or other data feed at the site of the recipient) or circuit-switched network (dedicated path for linear flow of data).

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A merged video feed generated based on:
receiving data representative of video feeds from video cameras capturing live sports games;
selecting, from said video feeds, only those live sports games which include players on a fantasy sports team for a viewer of a display screen;
selecting, in real-time, video clips from within said video feeds which show players on said fantasy sports team carrying out actions leading to and/or resulting in points for said fantasy sports team, wherein said points are based on scoring rules for a specific fantasy sports league;
sending said video clips via a network node in real-time or near real-time to said display screen.

2. The merged video feed of claim 1, wherein video clips closest to real-time are given priority in said step of sending.

3. The merged video feed of claim 2, wherein said selected video clips are queued for sending to said display screen, and a video clip occurring later in time within said video feeds is placed ahead of prior queued video clips based on more said points being scored for said fantasy sports team.

4. The merged video feed of claim 3, wherein a queued said video clip is dropped from said queue after a pre-determined period of time from a start or end of said video clip has passed.

5. The merged video feed of claim 4, wherein said pre-determined period of time is proportionally greater for video clips corresponding to more said points for said fantasy sports team.

6. The merged video feed of claim 1, comprising two simultaneously sent said merged video feeds to said displayed device, wherein each video feed is for a different said fantasy sports team.

7. The merged video feed of claim 3, wherein said step of sending comprises:
instructing a recording device to record at least a portion of one of said video feeds of said live said sports games and to exhibit said video clips on said display; and
switching between displaying said recorded video feeds of said live sports games at least one said live video feed based on said step of selecting and said step of queuing.

8. A merged video feed, generated based on:
receiving data, via a network node, of live video feeds for at least two concurrent sports games;
receiving a list of players on a fantasy sports team;
determining when a player of said fantasy sports team is exhibited in one of said live video feeds;
determining if said player is carrying out an action likely to lead to a point for said fantasy sports team;
sending to a display device of said merged video feed comprising one of said live video feeds exhibiting said player carrying out an action likely to lead to said point for said fantasy sports team;
at a later time, sending to a display device a different one of said live video feeds, when a different player is carrying out an action likely to lead to said point for said fantasy sports team.

9. The method of claim 8, carried out for two different said fantasy sports teams, wherein said sending to said display device comprises sending a merged video feed for each of said two different said fantasy sports teams.

10. The method of claim 8, wherein when two players of said fantasy sports team are carrying out an action likely to lead to a point for said fantasy sports team and each player of said two players is exhibited in a different said live video feed:
combining said live video feeds together and sending said simultaneous video feed to said display device.

11. The method of claim 8, wherein, when two players of said fantasy sports team are carrying out an action likely to lead to a point for said fantasy sports team, and each player of said two players is exhibited in a different said live video feed:
sending a first said live video feed to said display device based on an action exhibited there-in likely to result in more points for said fantasy sports team; and
when said action exhibited there-in is likely to result in more said points ends, or said points are scored sending a delayed feed of a second said live video feed to said display device.

12. The method of claim 11, wherein, when a new action likely to lead to a point for said fantasy sports team is detected before said delayed feed is sent to said display device, a video feed showing said new action is sent to said display device ahead of said delayed feed.

13. The method of claim 12, wherein said sending a video feed showing said new action to said display device is carried out, instead of sending said delayed feed of a second said live video feed only when said new action is likely to score a greater number of points for said fantasy football team.

14. The method of claim 8, wherein when a point is scored for said fantasy team and a portion of a video showing said player scoring said point was not shown, incorporating said portion of said video showing said player scoring said point into said merged video feed on a time delay basis.

15. The method of claim 8, wherein said incorporating into said merged video feed occurs only when no further said actions likely to lead to a point for said fantasy sports team are detected within a pre-defined period of time.

16. The method of claim 8, further comprising a step of instructing a recording device to record at least a portion of one of said video feeds of said live sports games and to exhibit said portion on said display; and
switching between displaying said portion and at least one said live video feed based on an action of a player on said fantasy sports team which is more likely to result in more points for said fantasy sports team.

17. The method of claim 14, wherein said merged video feed comprises each of said live feeds, as well as at least one recorded video clip stored on a device directly electrically coupled to said display device,
wherein said recorded video clip plays based on said time delay due to another said portion of said video being shown in said merged feed.

18. A merged video feed generated based on:
receiving data representative of video feeds of live sports games;
selecting, from said video feeds only those live sports games which include players on a fantasy sports team for a viewer of a display screen;
selecting, in real-time, video clips from within said video feeds which show players on said fantasy sports team carrying out actions leading to, and/or resulting in points for said fantasy sports team, wherein said points are based on scoring rules for a specific fantasy sports league; and
sending said video clips via a network node in real-time or near real-time to said display screen;
wherein video clips closest to real-time are given priority in said step of sending;
wherein said selected video clips are queued for sending to said display screen, and a video clip occurring later in time within said video feeds is placed ahead of prior queued video clips based on more said points being scored for said fantasy sports team;
wherein a queued said video clip is dropped from said queue after a pre-determined period of time from a start or end time of said video clip has passed;
wherein said pre-determined period of time is proportionally greater for video clips corresponding to more said points for said fantasy sports team; wherein when two players of said fantasy sports team are carrying out an action likely to lead to a point for said fantasy sports team and each player of said two players is exhibited in a different said live video feed:
combining said live video feeds together and sending said simultaneous video feed to said display device.
wherein when two players of said fantasy sports team are carrying out an action likely to lead to a point for said fantasy sports team and each player of said two players is exhibited in a different said live video feed:
sending a first said live video feed to said display device based on an action exhibited there-is likely to result in more points for said fantasy sports team; and
when said action exhibited there-is likely to result in more said points ends, or said points are scored sending a delayed feed of a second said live video feed to said display device;
and when a new action likely to lead to a point for said fantasy sports team is detected before said delayed feed is sent to said display device, sending a video feed showing said new action to said display device.
